(19) United States
(12) Patent Application Publication
(10) Pub. No.: US 2009/0002247 A1
(43) Pub. Date: Jan. 1, 2009

(54) Transmitting and/or Receiving Device Which Can be Applied to Garments and Garment Thus Obtained

(76) Inventor: Pedro Prat Gonzalez, Igualada (ES)

Correspondence Address: KED & ASSOCIATES, LLP, P.O. Box 221200, Chantilly, VA, 20153-1200, US

(21) Appl. No.: 11/630,242

(22) PCT Filed: Aug. 6, 2004
(86) PCT No.: PCT/ES04/00369

§ 371 Date: Dec. 31, 2007

(30) Foreign Application Priority Data
Jun. 21, 2004 (ES) P 200401577

(51) Int. Cl. H01Q 1/12

(52) U.S. Cl. 343/718

(57) ABSTRACT

The invention relates to a transmitting and/or receiving device which can be applied to garments and to the garment thus obtained. The aforementioned garments comprise at least one fabric or non-woven fabric having a maximum degree of elasticity. According to the invention, the transmitting and/or receiving device (1) takes the form of a spiral spring which may be flat, cylindrical, conical, voluted, in the form of a Greek key border, zigzag shaped or similar and which is joined to the fabric or non-woven fabric directly or by means of a base (2) acting as a support for the device (1). The aforementioned maximum degree of elasticity of the fabric or non-woven fabric is configured as a function of the tolerance characteristics of the transmitting and/or receiving device (1).

Transmitter and/or receiver device applicable to garments and the garment obtained, comprising at least fabric or non-woven fabric, with a maximum degree of elasticity, characterised in that the mentioned transmitter and/or receiver device is configured in the form of a spiral spring, which is flat, cylindrical, conical, scroll, Greek key border, zigzag or similar ones, joined to the fabric or non-woven fabric, either directly or by means of a base in the form of a support for the mentioned device, and the referred degree of maximum elasticity of the fabric or non-woven fabric is configured in function of the transmitter and/or receiver device tolerance specifications.

### BACKGROUND OF THE INVENTION

Various patents and utility models are known in the state of the art, in which transmitters and/or receptors are used in garments.

Thus, Spanish Utility Model No 200002068 (1046905) from the Camarero Roy brothers is known from the year 2002, which comprises a nappy with a perfected moisture detector, of the type consisting of a flexible laminar part that adapts to the baby's body, which includes a zone of moisture-absorbing material in the central part of one of its sides in contact with the body and also removable means to position and fix the nappy to the baby's body that is characterised in that the central zone occupied by the absorbent material contains three sensors: moisture, heat and electrochemical, with the last two monitoring urine temperature and chemical analysis and with these three sensors forming a transmitter that sends a signal to the receiver which emits an acoustic and luminous signal.

Spanish Utility Model No 200100027 (1048066) from Ms Alicia Crespo Guijarro, from the year 2001, is also known in the state of the art, which refers to a luminous publicity device applicable to garments and characterised in that it consists of a T-shirt or similar garment with an inside pocket containing a battery and a switch that passes electricity from the battery to concentric light-emitting filaments by means of wires.

Perhaps one of the examples that most quickly comes to mind consists of those devices that, for example, include a TAG applied to the garments or other objects for the purpose of sounding an acoustic alarm when transferred to a determined point by means of information transmission and reception.

### DISCLOSURE OF THE INVENTION PATENT

The previously described background does not resolve the possibility of permanently wearing the transmitter and/or receiver without damaging it, whether because the garment is washed, or folded or simple user movement, body turning and moving from one side to another.

In the background for the two described utility models, for example, the transmitter and/or receiver has significant measurements and, at the same time, make it unsuitable for putting into a washing machine or garments with a certain elastic component, since the structures are quite rigid.

Along these lines, the inventor has developed a transmitter and/or receiver that is elastic or possesses a degree of elasticity that allows it to be employed in garments with elastic components.

The previously described background can be employed in FIG. 2 or 3 of the examples, but can never be in both figures since they lack said condition of elasticity.

One objective of this invention is a transmitter and/or receiver device applicable to garments, comprising at least fabric or non-woven fabric, with a maximum degree of elasticity, characterised in that the mentioned transmitter and/or receiver device is configured in the form of a spiral spring, which is flat, cylindrical, conical, scroll, Greek key border, zigzag or similar ones, joined to the fabric or non-woven fabric, either directly or by means of a base in the form of a support for the mentioned device, and the referred degree of maximum elasticity of the fabric or non-woven fabric is configured in function of the transmitter and/or receiver device tolerance specifications.

Another objective of the present invention is a garments, of the type comprising at least fabric or non-woven fabric, with a maximum degree of elasticity, characterised in that it includes a transmitter and/or receiver device is configured in the form of a spiral spring, which is flat, cylindrical, conical, scroll, Greek key border, zigzag or similar ones, joined to the fabric or non-woven fabric, either directly or by means of a base in the form of a support for the mentioned device, and the referred degree of maximum elasticity of the fabric or non-woven fabric is configured in function of the transmitter and/or receiver device tolerance specifications.

This invention is particularly applicable to intelligent washing machines, for example, those that can be provided with information about the type of garment to be washed and that can select the most suitable wash program.

At the same time, it makes it impossible to remove this transmitter and/or receiver from the garment because it is securely fixed to it, which increases safety measures against shop fraud and can be used as an alarm in case of theft.

### BRIEF DESCRIPTION OF THE DRAWINGS

In order to facilitate the description, the present report is accompanied by seven sheets of drawings that show specific exemplary embodiments, which are cited as non-limiting examples of the scope of the present invention.

FIG. 1 is a plan view of the device with a plastic material base with a chip or microchip incorporated.

FIG. 2 is a view of a garment with a transmitter and/or receiver device.

FIG. 3 is a view of the garment of FIG. 2 in which the transmitter and/or receiver is linearly deformed in function of a force applied by the user to the fabric.

FIG. 4 is an exemplary embodiment of the referred transmitter and/or receiver in a bra.

FIG. 5 is an application of a transmitter and/or receiver device in the crotch.

FIG. 6 is a view of the device forming part of the actual fabric.

FIG. 7 is a view of the device in which it is wound around an elastic element in the form of a core, and

FIG. 8 is a view of the device in a silk-screening form.

### A SPECIFIC EMBODIMENT EXAMPLE OF THIS INVENTION PATENT

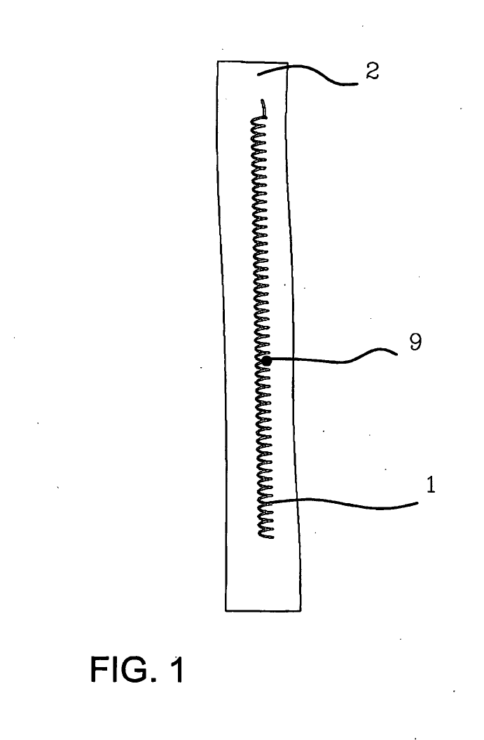

Thus, FIG. 1 shows a base 2, a chip or microchip 9 and a transmitter and/or receiver device.

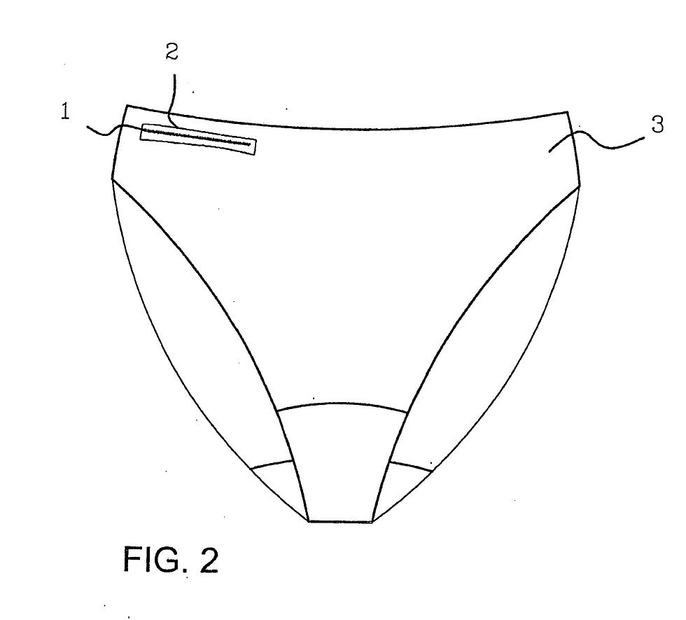

FIGS. 2, 3 and 5 show a pair of panties 3, the referred transmitter and/or receiver device 1 and the base 2.

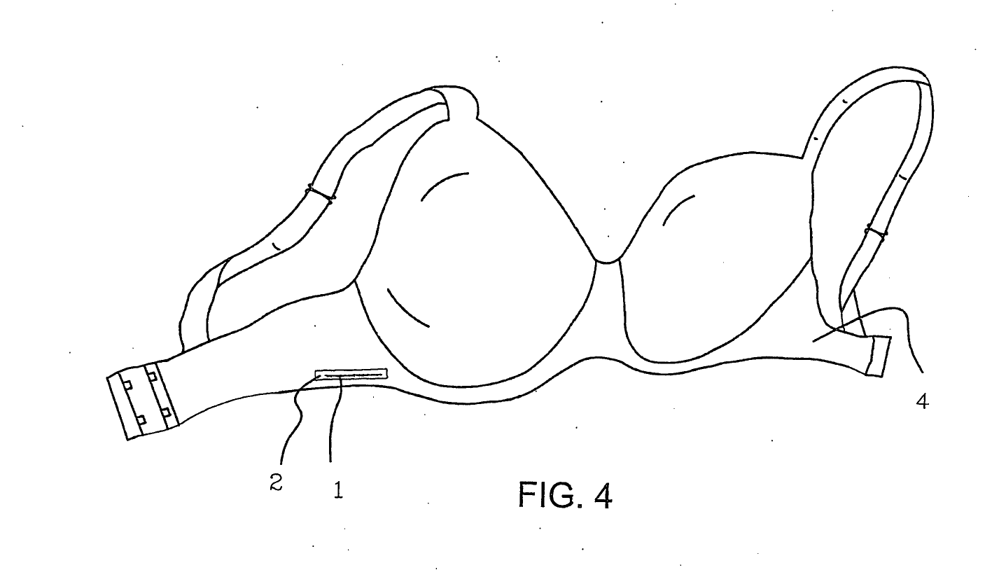

FIG. 4 shows a bra 4, the referred transmitter and/or receiver device 1 and the base 2.

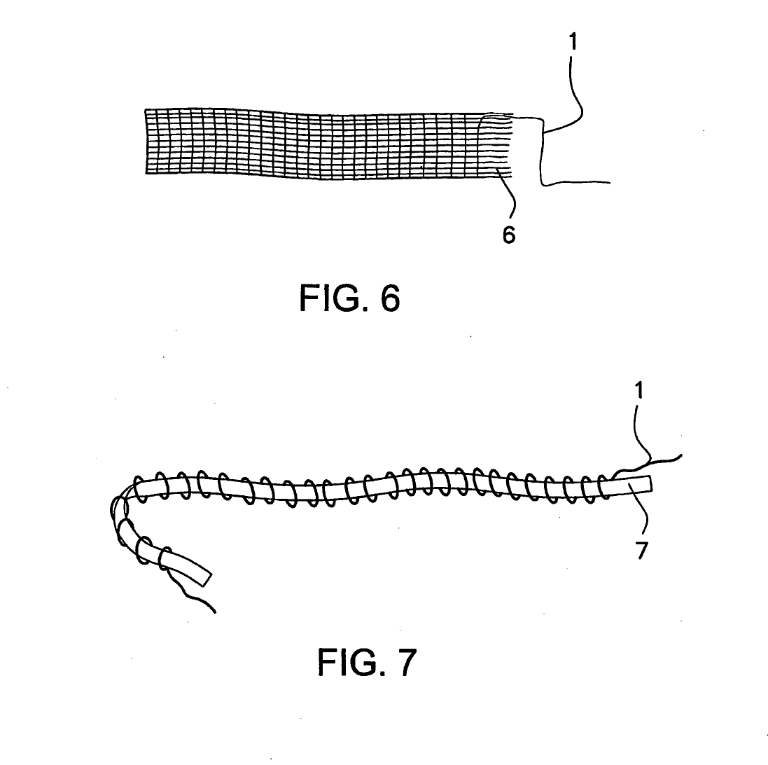

FIG. 6 is a sample of a direct join of the transmitter and/or receiver device 1 to the fabric or non-woven fabric, in other words, forming part of the actual fabric, for example, as weft, leaving the warp 6 for the elastic threads or filaments that are not used for transmission or reception.

FIG. 7 is an exemplary embodiment comprising a core 7, around which the transmitter and/or receiver device 1 is arranged.

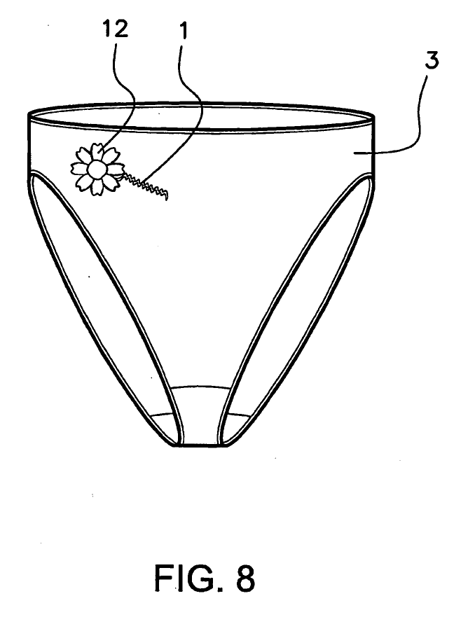

FIG. 8 is another exemplary embodiment showing a pair of panties 3, with a silk-screened motif 12 incorporating a transmitter and/or receiver device 1, similarly silk-screened.

Thus, in a specific exemplary embodiment, there is a transmitter and/or receiver 1, adopting the form of a spring, or spiral spring, which can be flat, cylindrical, conical, scroll, Greek key border, zigzag or similar.

In fact, depending on the type of garment or requirements, one type of spiral spring or another may be adopted.

Thus, said transmitter and/or receiver 1, configured in the form of a spiral spring, on an elastic base 2, for example polyurethane, although it could also be an olefin, polyolefin synthetic or natural rubber or similar materials, or a combination of these.

Subsequently, said base 2 is joined to the specific garment 3, 4.

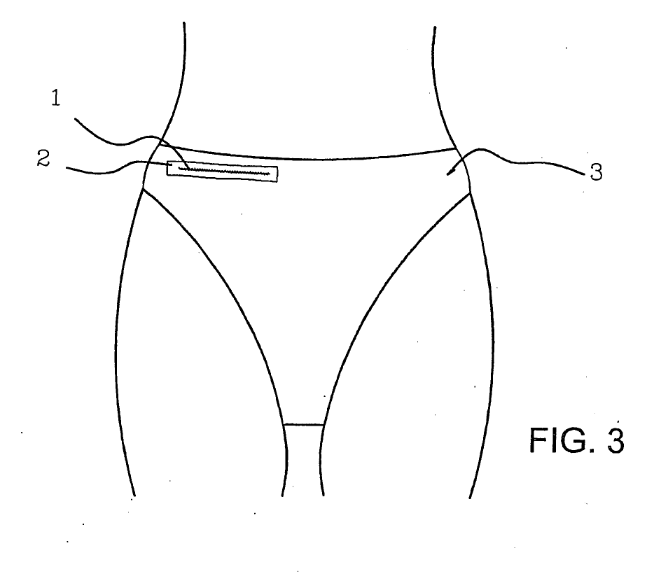

Thus, when the user puts on a garment 3, FIG. 2, the transmitter and/or receiver 1 is in a rest situation, or with a certain degree of elasticity. When the garment is worn, FIG. 3, the transmitter and/or receiver stretches to adapt to the new garment 3 size, while maintaining its technical specifications intact.

Once the user removes the garment 3, the transmitter and/or receiver 1 is able to return to its initial position thanks to the base 2.

The fact that the base 2 is manufactured from an elastic material, such as polyurethane, olefin, polyolefin, synthetic or natural rubber, or similar materials or a combination of these, facilitates adaptation of the transmitter and/or receiver 1 to the new garment 3, 4 sizes, together with it being washed and folded etc, without danger of being damaged.

Although not illustrated, there is the possibility of said base 2 incorporating a memory bank linked to the transmitter and/or receiver 1 in order to store a determined type of information, for example, fabric type, manufacturer's information and washing instructions etc, which could replace the traditional labels and, as previously stated, could be used a and anti-fraud device (as a tag), or in intelligent washing machines, providing information of the garments characteristics.

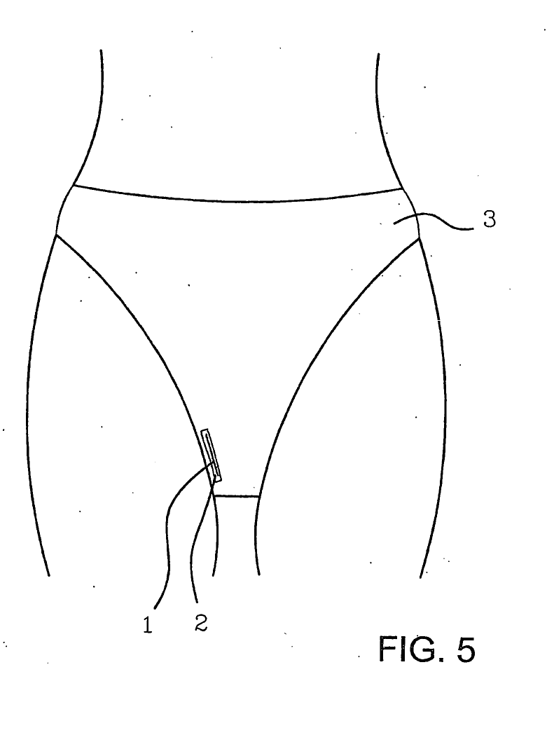

Positions other than that of the crotch in FIG. 5 have been indicated, or in other garments 4, as in FIG. 4, a bra, which are merely non-limiting examples.

It must be pointed out that the maximum degree of elasticity of the fabric or non-woven fabric is configured in function of the transmitter and/or receiver device tolerance specifications, in other words, if, for example, the antenna in Europe has a transmission band of between 700 and 950 MHz and in the USA this limit is between 800 and 1,000 MHz, said maximum elasticity must be able to adapt itself, depending on sale location being Europe or USA in order to allow the transmitter and/or receiver device to transmit and receive under these conditions.

In another exemplary embodiment, the transmitter and/or receiver device 1 comprises at least one metal or conducting polymer wire or filament or with a conducting covering, located wither in the weft as illustrated in FIG. 6, or in the fabric warp 6. It may be distributed throughout the garment or only in a part of it (for example, in a strap or edge etc). In this way, when the fabric or non-woven fabric is stretched the flat, cylindrical, conical, scroll, Greek key border, zigzag or similar spiral spring configuration of the mentioned transmitter and/or receiver device 1 is able to stretch and recover its position once the extending force is removed.

FIG. 7 shows another variant in which the transmitter and/or receiver device 1 comprises a core 7 made from polyurethane, an olefin or polyolefin, synthetic or natural rubber or similar material covered by at least one metal or conducting polymer wire or filament or conducting covering in the form of a flat, cylindrical, conical, scroll, Greek key border, zigzag or similar spiral spring, all configured as a thread inside, or of the fabric or garment, with said device integrated into the textile or garment structure.

In this case, as for the example of FIG. 6, the transmitter and/or receiver device 1 forms part of the fabric or non-woven fabric, with the elastic media or core 7 being the element that allows the extension and recovery of the device.

If covering referred to in the previous examples is made of metal, copper or silver may be employed, for example, if, on the other hand it is not metal, then conducting polymer materials, such as polyanilene or polypyrol may be employed. As merely an example, it can be pointed out that said covering can be accomplished via immersion in a cationic bath or via plasma.

In another exemplary embodiment example shown in FIG. 8, the transmitter and/or receiver device 1 can form part of a motif 12 on a pair of panties, for example, formed by a metallic and/or conducting ink that is silk-screened by stamping or digital printing etc onto the elastic fabric, non-woven fabric or elastic base, with said silk-screening adopting the described form being flat, cylindrical, conical, scroll, Greek key border, zigzag or similar, so that spiral spring, when the garment is stretched, the silk-screening is also stretched, but without losing its transmitting and receiving properties.

It is also possible, but not shown in the drawings, for the described device to comprise at least one filament integrated into a texturised or similar thread, so that because of this texturisation, it tends to contract in its resting position, with a covering of conducting material.

In other words, the intention is for the wire or filament in a resting position, already adopts the form of a flat, cylindrical, conical, scroll, Greek key border, zigzag or similar spiral spring, being able to extend itself to reach a maximum degree of elasticity in accordance with its tolerance specifications and recover its initial resting position once the force acting on said texturised wires or filaments has been completely removed.

Similarly, the described texturised wire or similar can be integrated into a structure that is, in turn, formed of several texturised wires or similar.

It is intended to provide the device 1 with protection against attack by external agents, namely human sweat, detergents and seawater etc.

As an information storage method, together with incorporating the control for the device 1, this can be associated with a chip or microchip 9 (FIG. 1) that will also be protected against the previously mentioned external agents.

The new features of the invention lie both in the device itself as well as in its application to garments.

The present invention patent describes a new transmitter and/or receiver device applicable to garments and the garment obtained. The examples described here do not limit the present invention and it may have various applications and/or adaptations, all of which are within the scope of the following claims.

1-26. (canceled)

27. An emitting and/or receiving device applicable to clothing articles that include a woven or non-woven material with a degree of elasticity, characterized in that the emitting and/or receiving device is formed into a shape that is at least one of spiral, flat, cylindrical, conical, scroll shaped, and zigzag shaped, and wherein the emitting and/or receiving device in integrated into the woven or non-woven material by means of a base which acts as a support for the emitting and/or receiving device, and wherein the elasticity of the woven or non-woven material is not formed based on the characteristics of tolerance of the emitting and/or receiving device.
